(19) United States
(12) Patent Application Publication
(10) Pub. No.: US 2006/0135342 A1
(43) Pub. Date: Jun. 22, 2006

(54) Method of making alkali metal silicate glass, feedstock, and glass article formed therefrom

(76) Inventors: James G. Anderson, Dundee, NY (US); Adam J. G. Ellison, Painted Post, NY (US); Sabyasachi Sen, Davis, CA (US)

Correspondence Address: CORNING INCORPORATED, SP-TI-3-1, CORNING, NY, 14831, US

(21) Appl. No.: 11/021,903

(22) Filed: Dec. 21, 2004

(51) Int. Cl. C03C 6/00; C03B 37/014; C03B 37/027

(52) U.S. Cl. 501/27; 65/404; 65/395; 65/429

(57) ABSTRACT

A method of making an alkali metal silicate glass includes preparing an alkali metal feedstock having a first desired level of alkali metal, the alkali metal feedstock being essentially free of an element that absorbs between 0.8 and 2.5 μm in any valence state. The method also includes combining and mixing the alkali metal feedstock with at least one silicate feedstock to form a precursor material having a second desired level of alkali metal and melting the precursor material to form molten glass.

### FIELD OF THE INVENTION

The invention relates to methods of making silicate glasses. More specifically, the invention relates to a method of making an alkali metal silicate glass, an alkali metal silicate precursor, and glass articles containing alkali metal silicate glass.

### BACKGROUND OF THE INVENTION

Optical fibers in commercial use are mostly based on silica glass. The theoretical minimum attenuation of pure silica is generally accepted to be about 0.15 dB/km at 1550 nm. For optical fibers based on silica glass, attenuation losses have been reduced to the point where most of the remaining attenuation is due to intrinsic scattering within the glass material. It has been demonstrated that intrinsic scattering loss in silica glass can be effectively reduced by doping silica glass with alkali metals, either alone or in combination with other materials such as fluorine. (Lines, Malcolm E., “Can the minimum attenuation of fused silica be significantly reduced by small compositional variations? I. Alkali metal dopants,” Journal of Non-Crystalline Solids 171 (1994) 209-218; Lines, Malcolm E., “Can the minimum attenuation of fused silica be significantly reduced by small compositional variations? II. Combined fluorine and alkali metal dopants,” Journal of Non-Crystalline Solids 171 (1994) 219-227; U.S. Pat. No. 5,146,534.)

Optical fibers exhibiting low losses are commonly manufactured by chemical vapor deposition (CVD) processes. However, it appears that it would not be possible to dope silica glass with alkali metals using conventional CVD processes such as outside vapor deposition (OVD), inside vapor deposition (IVD), vapor axial deposition (VAD), and modified CVD (MCVD), wherein soot is a precursor to the final glass. It is well known that alkali metals may crystallize in silica. Thus, the soot produced by these processes would tend to crystallize before it can be sintered into dense glass, resulting in both cristobalite defects in the final glass and near-total volatilization of the alkali metal dopant. The soot produced by these processes would also generally contain H₂O, which may dissociate during further processing of the soot to form OH. OH has a deleterious effect on fiber attenuation, particularly when present in the core of the fiber. Typically, this OH is removed by flowing chlorine through the soot preform at an elevated temperature. Unfortunately, this chlorine drying step will strip what little alkali metal remains in the soot.

U.S. Pat. No. 4,336,048 (van der Steen et al.) describes a method of producing quartz glass containing 0.035 mol % to 3 mol % (computed on the basis of the oxides) of alkali metal dopants. The method involves mixing quartz powder having purity of at least 99.99 mol % SiO₂ with a pulverized concentrate. The concentrate is obtained by sintering or fusion of quartz with the desired dopants. The mixture is fed to a melting furnace and molten doped quartz glass is discharged from the furnace in a continuous process. The method is carried out in a He/H₂ atmosphere. However, in this atmosphere, H₂ will combine with SiO₂ to produce H₂O in the doped quartz glass, which will then cause unwanted absorption in the infrared range. Furthermore, the required presence of H₂ suggests the use of a molybdenum (Mo) melting chamber, which would result in Mo in the glass, which would also cause unwanted absorption in the glass.

From the foregoing, a method of making silicate glass with appropriate alkali metal doping level is desired. In particular, such glass may be useful to form the core of a high performance, low loss optical fiber.

### SUMMARY OF THE INVENTION

In one aspect, the invention relates to a method of making an alkali metal silicate glass which comprises (a) preparing an alkali metal feedstock having a first desired level of an alkali metal, the alkali metal feedstock being essentially free of an element that absorbs between 0.8 and 2.5 μm in any valence state, (b) combining and mixing the alkali metal feedstock with at least one silicate feedstock to form a precursor material having a second desired level of the alkali metal, and (c) melting the precursor material to form molten glass.

In one embodiment, the element that absorbs between 0.8 and 2.5 μm in any valence state is a transition metal selected from the group consisting of Co, Cr, Cu, Fe, Mn, Ni, Ti, and V. In another embodiment, the element that absorbs between 0.8 and 2.5 μm in any valence state is a metal selected from the group B of the periodic table of elements.

In a preferred embodiment, the method further comprises forming the molten glass into a glass article. In one embodiment, the glass article is a rod-shaped optical fiber precursor. In another embodiment, the molten glass is formed into a glass article by casting. In another aspect, melting the precursor material into molten glass and forming the molten glass into a glass article occur in a single process. According to one embodiment, the single process comprises piling the precursor material onto a platform positioned in a furnace while translating the platform along the furnace from a first zone wherein the precursor material melts into glass to a second zone wherein the glass rapidly quenches into a solid body.

In a preferred embodiment, melting occurs in an environment that is substantially free of hydrogen. In another embodiment, melting occurs in an inert or oxidizing environment.

In one embodiment, the level of alkali metal in the precursor material is in a range from approximately 0.035 to 6 mol %. In another embodiment, the level of alkali metal in the precursor material is in a range from approximately 0.1 to 3 mol %. In a preferred embodiment, the precursor material comprises at least 80 mol % silica. In one embodiment, the level of alkali metal in the alkali metal feedstock is at least 10 mol %.

In another aspect, the invention is a precursor comprising a mixture of an alkali metal feedstock and a silicate feedstock, the mixture comprising 0.035 to 6 mol % and at least 80 mol % silica, wherein the alkali metal feedstock is essentially free of an element that absorbs between 0.8 and 2.5 μm in any valence state, and the alkali metal feedstock is substantially uniformly distributed within the silicate feedstock.

In yet another aspect, the invention is a glass article which comprises an alkali metal in an amount of 0.035 to 6 mol % and silica in an amount of at least 80 mol %, wherein the glass article is essentially free of an element that absorbs between 0.8 and 2.5 μm in any valence state, and the alkali metal is substantially radially uniformly distributed within the glass article.

Other features and advantages of the invention will be apparent from the following description and the appended claims.

### BRIEF DESCRIPTION OF THE DRAWINGS

FIG. 1 is a flowchart of a method of making an alkali metal silicate glass according to one embodiment of the invention.

FIG. 2 is a flowchart of a process for making a feedstock of alkali metal silicate according to one embodiment of the invention.

FIG. 3 illustrates molten glass being formed into a glass article according to one embodiment of the invention.

FIGS. 4A-4C illustrate a method of melting feedstock and forming the melt into a glass article in a single process according to one embodiment of the invention.

### DETAILED DESCRIPTION OF THE INVENTION

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

Embodiments of the invention provide a method of making an alkali metal silicate glass. An alkali metal level in the silicate glass of 0.1 to 3 mol %, computed on the basis of oxides, is generally considered useful for making an optical fiber with low intrinsic scattering loss. However, alkali metal silicate glasses according to embodiments of the invention can contain any desired level of alkali metal. In accordance with a further aspect of the invention, the alkali metal silicate glass may be used to form an optical fiber precursor. The term “optical fiber precursor,” as used herein, refers to a complete optical fiber preform, or a precursor to a complete optical fiber preform, such as, for example, a core cane or a deposition tube. The term “core cane,” as used herein, refers to a consolidated glass precursor to an optical fiber preform that is not a complete optical fiber preform but that includes at least a portion corresponding to the fiber's core, i.e., that which carries light. The term “optical fiber preform,” as used herein, refers to a consolidated glass article ready for drawing into an optical fiber.

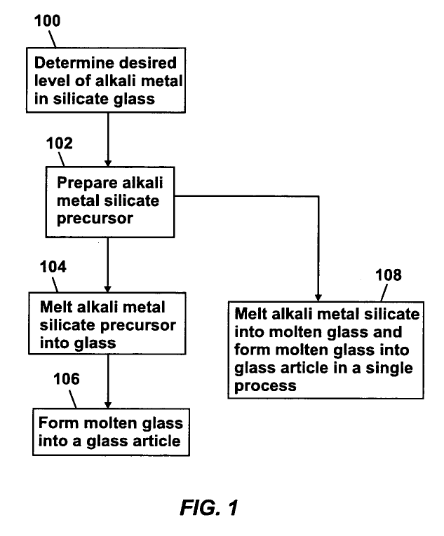

FIG. 1 is a flowchart of a process for making an alkali metal silicate glass according to one embodiment of the invention. An alkali metal silicate glass according to an embodiment of the invention includes at least 80 mol % silica, preferably at least 90 mol % silica. The alkali metal silicate glass may include one or more alkali metals. The alkali metals may be selected from the group consisting of K, Na, Li, Cs, and Rb. In the silicate glass, the alkali metal bonds with oxygen to form Si—O—X linkages, wherein X is a member of the preceding group. Optionally, the alkali metal silicate glass may include one or more additional dopants. Dopants useful in optical fibers include, but are not limited to, F, Al₂O₃, CaO, GeO₂, and P. The process for making the alkali metal silicate glass preferably includes determining the desired level of alkali metal in the silicate glass (100). In one embodiment of the invention, the desired level of alkali metal in the alkali metal silicate glass is in a range from 0.035 to 6 mol %, preferably 0.1 to 3 mol %.

The process for making an alkali metal silicate glass further includes preparing an alkali metal silicate precursor (102). In one aspect, the process further includes heating and melting the alkali metal silicate precursor into glass (104), after which the molten glass is preferably formed into a glass article (106). The molten glass may be formed into a glass article by any suitable process, such as casting (e.g., by pouring the molten glass into a mold) or drawing (e.g., by draining the molten glass from a heated cavity, such as a crucible). In one embodiment, the glass article is an optical fiber precursor, such as a rod-shaped core cane. In another aspect, the process includes heating and melting the silicate precursor into glass and forming the molten glass into a glass article in a single process (108). Steps 102 to 108 will now be described in greater detail. In the course of describing steps 102 to 108, potassium (K) will be used as an example of a preferred alkali metal to be incorporated in the silicate glass. However, the invention should not be construed as limited to potassium silicate glass. As previously mentioned, alkali metals useful in the invention may be selected from the group consisting of K, Na, Li, Cs, and Rb, and combinations thereof.

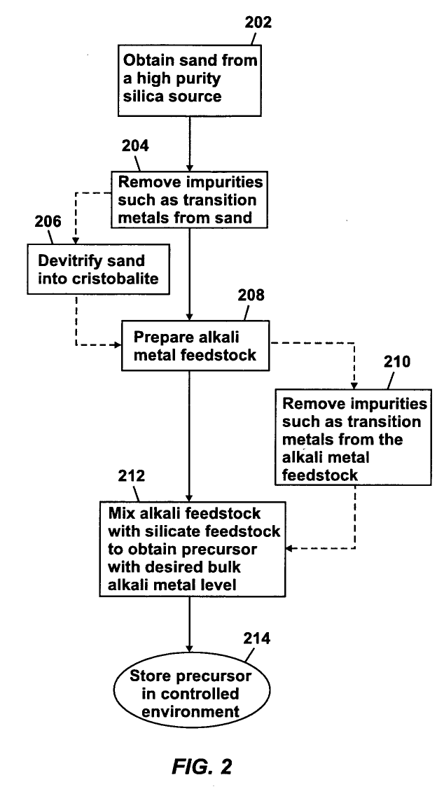

FIG. 2 illustrates a process for preparing an alkali metal silicate precursor according to one embodiment of the invention. It is preferable that the alkali metal silicate precursor is essentially free of elements that absorb between 0.8 and 2.5 μm in one of their valence states since presence of these elements in the alkali metal silicate precursor would make it difficult to achieve an alkali metal silicate glass having low attenuation. These elements are typically group B metals, in particular group B transition metals. Accordingly, it is preferable that the alkali metal silicate precursor is essentially free of group B transition metals. The term “essentially-free” means, for example, that transition metals, such as, for example, Co, Cr, Cu, Fe, Mn, Ni, Ti, and V (period 3 transition metals), are not present in more than trace amounts. Generally, this would mean that transition metals are present in the silicate precursor in amounts less than 20 ppm, and more preferably below the detection limit. It should also be recognized that high OH content in the alkali metal silicate precursor would also make it difficult to achieve an alkali metal silicate glass having low attenuation. Therefore, it is preferable that the alkali metal silicate precursor has a low OH content, preferably less than approximately 100 ppb, more preferably less than approximately 20 ppb. Moreover, high chlorine content in the alkali metal silicate precursor may have deleterious effects on retention of alkali metal in the silicate glass, and may further cause processing problems when making fiber. Therefore, the chlorine content of the alkali metal silicate precursor is preferably less than 500 ppm, in some embodiments less than 100 ppm, and in further cases less than 50 ppm.

The process of preparing the alkali metal silicate precursor may include obtaining sand from a high purity silica source (202). In one embodiment, the high purity silica source is at least 99.999% pure on a metals basis. High purity fused silica made by a boule process is an example of a high purity silica source. The boule process involves a chemical vapor reaction by passing a silica precursor into a flame of a burner to convert the silica precursor to soot. The soot is then directed downwardly to a bait, deposited thereon, and immediately consolidated into dense, transparent, bulk glass called boule. High purity fused silica made from a CVD process (e.g., MCVD, PCVD, IVD, OVD, and the like) is another example of a high purity silica source. The silica source may be entirely silica or may be comprised of silica and one or more dopants. Such dopants may be added by flood doping the soot or by suitable CVD processes. In one embodiment, the sand is obtained by milling, grinding, or otherwise pulverizing the high purity silica source. In one embodiment, milling is achieved using soft iron implements which would allow resulting contamination in the sand to be easily removed by acid leaching. The sand may also be obtained from commercial sources. For example, high-purity sand derived from Corning HPFS® fused silica glass is available from Mintec Corp. under the trade name Syn 50.

Table 1 shows a trace element analysis of two sands suitable for use in the invention. Sand A is available from Mintec Corp. under the trade name Syn 50. Sand B is made by milling optical waveguide blanks made by a known CVD process. The trace element analysis in Table 1 shows that the sand obtained from the high purity silica source contains impurities. In particular, the sand contains period 3 transition metals, some of which may have been introduced during the milling process.

TABLE 1

| Transition Metals | Sand A (mol %) | Sand B (mol %) |
|---|---|---|
| Co | <0.01 | <0.01 |
| Cr | 0.07 | 0.05 |
| Cu | <0.01 | 0.05 |
| Fe | 0.53 | 0.47 |
| Mn | <0.01 | <0.01 |
| Ni | 0.03 | 0.03 |
| Ti | 0.26 | 0.02 |
| V | <0.01 | <0.01 |

The process of preparing the alkali metal silicate precursor further includes removing impurities, in particular group B transition metals, from the sand (204). In one embodiment, impurities are removed from the sand by acid leaching. The following procedure has been found to be effective in completely removing period 3 transition metals (listed in Table 1) from the sand:
1. Load 2 kg of silica sand into 1 gallon acid leached Nalgene® container.
2. Combine high purity HCl with 18 MΩ deionized water to make 5% HCl solution.
3. Add 1.4 kg of HCl solution to Nalgene® container.
4. Wrap gap between container lid and container with multiple layers of Teflon tape.
5. Place container on its side on a roller mill and operate mill for 72 hours.
6. Remove container from mill and wipe down the container with soap and water, followed by high purity ethanol.
7. Drain the HCl solution from the container and add 1.2 kg of fresh HCl solution to the container.
8. Load container with 1.2 kg deionized water.
9. Roll container for 1 hour and drain the water from the container.
10. Repeat steps 8 and 9 two more times.
11. Transfer the sand to a high purity quartz crucible and fire to 1000° C. for 1 hour to remove water.

If the water content of the high purity silica source from which the sand is derived is high, the water content in the sand will also be high. For example, Corning HPFS® has a typical OH content of 800 to 1,000 ppm, and the sand derived from this source may have comparable OH content. An OH content of this magnitude would make it difficult to achieve the desired low fiber attenuation. For cases where the sand has a high OH content, the process of preparing the silicate precursor preferably also includes eliminating water from the sand by, for example, devitrifying the sand into cristobalite (206). In one embodiment, solution doping a small amount of spectroscopic-purity KBr onto the sand and firing it to 1400° C. for 6 hours is sufficient to completely devitrify the sand into cristobalite, with the resulting cristobalite showing undetectably low levels of H₂O, i.e., less than 20 ppb. The following procedure has been found to be effective in completely devitrifying the sand into cristobalite:
1. Dissolve 1 g of spectroscopic grade KBr into 10 grams of 18 MΩ deionized water.
2. Add KBr solution to 1 kg of sand.
3. Roll KBr solution and sand for 4 hours to distribute KBr over the entire surface of the sand.
4. Load the KBr-doped sand into a fused quartz crucible and fire at 1400° C. for 6 hours.

Table 2 shows trace element analysis of Sand A before and after devitrifying the sand into cristobalite. For the data shown in Table 2, Sand A was not acid leached before devitrification into cristobalite. The impurity levels in Sand A before and after devitrifying (without acid leaching) are comparable, indicating that devitrification does not introduce additional contaminants into the sand. Preferably, the cristobalite is stored in a controlled environment, such as a dry box, until ready for use.

TABLE 2

| | Sand A (mol %) | Sand A (mol %) |
|---|---|---|
| Transition Metals | (before devitrification) | (after devitrification) |
| Co | <0.01 | <0.01 |
| Cr | 0.07 | 0.01 |
| Cu | <0.01 | <0.01 |
| Fe | 0.53 | 0.44 |
| Mn | <0.01 | <0.01 |
| Ni | 0.03 | 0.04 |
| Ti | 0.26 | 0.26 |
| V | <0.01 | <0.01 |

The process of preparing the alkali metal silicate precursor further includes preparing an alkali metal feedstock (208). The term “alkali metal feedstock,” as used herein, refers to an alkali-containing particulate solid material. The alkali metal feedstock is used to produce a glass with a low, uniform level of alkali doping. The alkali metal feedstock comprises one or more alkalis and silicon, preferably at least 10 wt % alkali oxide or oxides. The feedstock is essentially free of an element that absorbs between 0.8 and 2.5 μm in any valence state. What is meant by essentially free is that the feedstock has a 99.999% purity on a materials basis. In one embodiment preparation of the alkali metal feedstock involves obtaining a high purity alkali metal source. For example, the best high purity alkali metal sources of potassium are potassium nitrate and potassium super oxide (KO₂), both of which are available at extraordinarily high purity in simple reagent form. Appropriate quantities of the high purity alkali metal and a high purity silica sand, such as obtained at step 204 or 206, are combined and mixed to form the alkali metal silicate precursor. For example, 80% SiO₂ and 20% K₂O is a particularly useful composition because it is near the minimum liquidus point in the K₂O—SiO₂ binary and is readily melted to pure dry glass at 1475° C. The following procedure may be used to make the alkali metal feedstock:
1. Load high purity silica sand and high purity alkali metal source into an acid leached Nalgene® container and mix together using a Turbular® shaker mixer.
2. Transfer mixture into a high purity fused silica crucible. If desired, 0.5 mol % high purity KF can be added to eliminate water from the final glass.
3. Cover the crucible with a lid and load the crucible in a glowbar furnace at 1475° C. for 4 hours.
4. Transfer crucible to heated graphite receptacle to form a boule from the melt.
5. Invert the receptacle so that the crucible can shatter off the boule.
6. Crush the boule.

The process of preparing the alkali metal silicate precursor optionally includes removing impurities (210), such as group B transition metals, from the alkali metal feedstock (208). These impurities may have been introduced during crushing of the boule obtained at step 208. If the boule obtained at step 208 is crushed using, for example, fused silica media inside of a plastic jar (as opposed to, for example, soft metallic implements), this step may not be needed. The alkali metal feedstock may be sufficiently purified by acid leaching. The concentrate has a low durability; therefore, acid leaching of the feedstock should be fast. As an example, for a potassium silicate feedstock, 15 minutes leach in 5% HF+5% HNO₃ is sufficient to eliminate all surface contamination, followed by firing under flowing O₂ at 550° C. overnight.

The process of preparing the alkali metal silicate precursor further preferably includes combining the alkali metal feedstock (obtained at step 208 or 210) with a silica feedstock to obtain an alkali metal silicate precursor with the desired bulk alkali metal level (212). The term “silica feedstock,” as used herein, is a silica-containing particulate solid material. The alkali metal feedstock and silica feedstock are preferably mixed to the point where the alkali metal feedstock is substantially uniformly distributed throughout the silica feedstock. What is meant by “substantially distributed” is that any representative sample is within the nominal ±5% of target composition. Preferably, the silica feedstock is a high purity material. Preferably, the silica feedstock is essentially free of elements that absorb between 0.8 and 2.5 μm in one of their valence states. Most preferably, the silicate feedstock comprises SiO₂ and GeO₂ and/or F. In a preferred embodiment, the silica feedstock is prepared according to steps 202, 204, and, optionally, 206 described above. Weighing of the alkali metal feedstock and the silica feedstock is preferably performed under a controlled environment, such as a dry box or a laminar flow hood. As an example, the materials may be weighed into an acid leached Nalgene® container (or other suitable container) and mixed using a Turbular® shaker mixer (or other suitable mixer) for about 1 hour. The alkali metal silicate precursor (i.e., mixture of alkali metal feedstock and silica feedstock) can be stored in a dry box until ready for use (214).

Returning to FIG. 1, the alkali metal silicate precursor prepared as described above is heated and melted into glass in batches (104). Melting preferably occurs in an atmosphere that is substantially free of hydrogen. Generally, this would mean that the hydrogen content of the melting atmosphere is less than 100 ppm. Preferably, melting occurs in an inert atmosphere (e.g., He, Ar, Ne) or oxidizing atmosphere (e.g., O₂, air, SF₆, F₂, and Cl₂ or mixtures thereof). The oxidizing atmosphere may include an inert gas. In one embodiment, a batch is loaded into a heated cavity, such as a high purity refractory crucible. Alumina crucibles are suitable for melts performed up to 1800° C., but higher temperatures generally require zirconia (Y or Ca-stabilized) crucibles. The crucibles can be purified, e.g., by acid leaching, beforehand; however, experience suggests that near-zero contamination from the crucible will result because the very high viscosities of the melts preclude significant diffusion. The crucible is loaded into a furnace whose atmosphere consists entirely of a hydrogen-free atmosphere of high-purity inert gas, such as helium (He), and is melted at temperatures between 1800 and 2150° C. The duration of the melting process depends upon the melting temperature of the batch materials. For example, 30 minutes at 2150° C. is sufficient to melt pure SiO₂ into optical glass but 24 hours at 1800° C. seems to be required to melt 3K₂O-97SiO₂ into high-quality glass. A He environment makes it possible to obtain bubble-free glass.

The molten glass formed at step 104 may now be formed into a glass article (106). In one embodiment, forming the molten glass into a glass article includes casting the glass by, for example, pouring the molten glass into a mold. In another embodiment, forming the molten glass into a glass article includes drawing the molten glass from, for example, a crucible. In this case, the resulting glass article may be an optical fiber precursor.

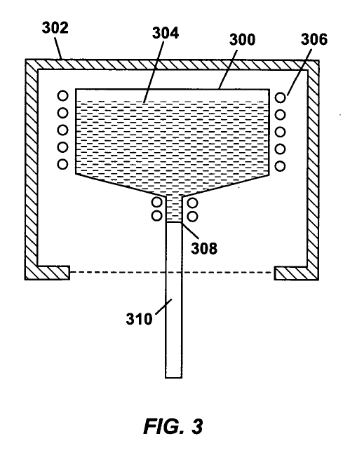

FIG. 3 illustrates a crucible 300 for forming a glass article. The crucible 300 comprises a heated cavity and is disposed in a furnace 302. The crucible 300 contains molten glass 304 formed in step (104 in FIG. 1). Heaters 306 are positioned about the periphery of the crucible 300 to keep the glass 304 in a molten condition. To form the glass article, an orifice 308 at the bottom of the crucible 300 is opened, allowing the molten glass 304 to flow out of the crucible 300 in a controlled manner. The molten glass 304 rapidly quenches into a solid glass article 310 once it emerges from the crucible 300. Suitable temperature controls may be employed to control the diameter of the solid glass article 310. The solid glass article 310 may be used as an optical fiber precursor, e.g., a core cane. The solid glass article 310 can be cut into segments, which can serve as deposition surfaces for additional core material or cladding. The core or cladding material may be deposited by a CVD process or by any other suitable method to form a complete preform that can be drawn by known methods into an optical fiber having a desired dimension. The optical fiber would have a core including alkali metal silicate glass that is essentially free of elements that absorb between 0.8 and 2.5 μm in any valence state, and which may also be essentially free of OH and chlorine. The molten glass 304 may also be cast or otherwise drawn into a hollow cylindrical glass shape instead of a solid rod-like glass shape using bellows.

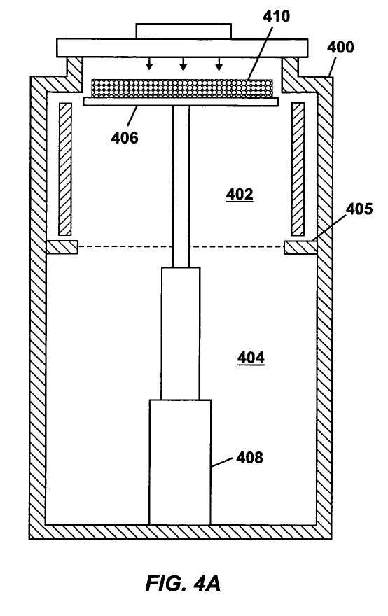

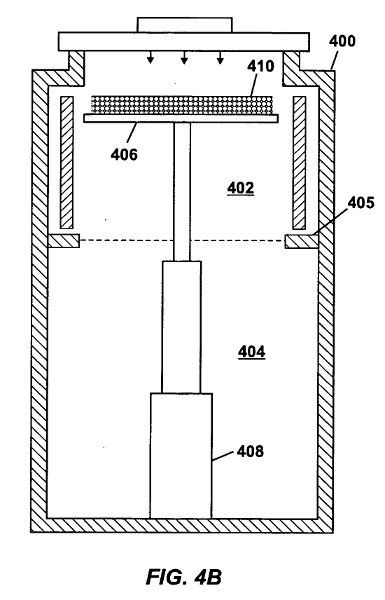

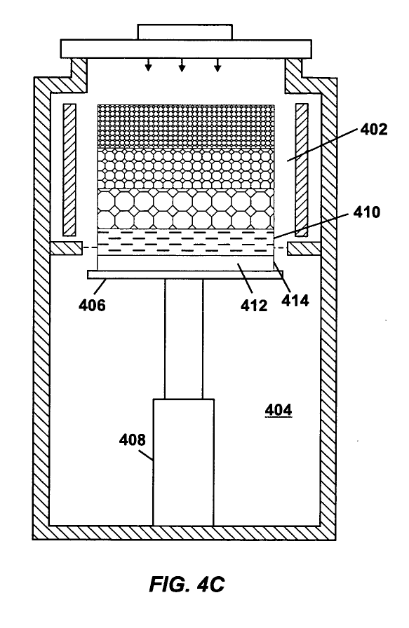

Returning to FIG. 1, the alkali metal silicate precursor may be alternatively melted into glass and formed into a glass article in a single process. FIGS. 4A-4C illustrate such a process. Referring to FIG. 4A, the process takes place in a vertical furnace 400 having a hot zone 402 and a cold zone 404. An insulating barrier 405 may separate the hot zone 402 from the cold zone 404. A platform 406 is disposed in the hot zone 402. A mechanism 408, such as a hydraulic or pneumatic cylinder or other suitable actuator, is coupled to the platform 406 to translate the platform 406 from the hot zone 402 to the cold zone 404. An inert atmosphere, such as a helium atmosphere, or an oxidizing atmosphere is preferably maintained inside the furnace 400.

In operation, the platform 406 is initially positioned at the top of the hot zone 402. A batch of the alkali metal silicate precursor is loaded on top of the platform 406, creating a batch pile 410. The platform 406 moves down slightly to place the top of the batch pile 410 at the top of the hot zone 402, as shown in FIG. 4B, making room for more batch materials to be added to the pile 410. As batch materials are added to the batch pile 410, the platform 406 is lowered to make more room for batch materials. The hot zone 402 is designed to be long enough so that by the time the platform 406 reaches the bottom of the hot zone 402, the batch pile 410 has melted into clear glass, as shown in FIG. 4C. As an example, the translation rate of the platform 406 could be approximately 0.5 mm per minute and the length of the hot zone 402 could be approximately 15 cm. Once the clear glass emerges from the hot zone 402, the glass rapidly quenches into a solid mass 412 and then supports the batch materials above. In this way, a solid glass article 412 having an untouched surface 414 can be practically achieved. The diameter of the batch pile 410 should be small so that the radial temperature across the batch is uniform. As an example, the diameter of the batch pile 410 could be limited to approximately 5 cm.

The invention typically provides the following advantages. A high purity silicate glass containing alkali metal can be made using the method of the invention. The high purity silicate glass can serve as the core of a high performance, low loss optical fiber. One particular advantage of the invention is that glass articles may be preferably formed having alkali metal dopant which is substantially uniformly distributed therein. Accordingly, optical fiber perform precursors may be made having radially invariant concentrations of alkali metal dopant. What is meant by “radially invariant concentration” is that the concentration of alkali metal at any point across the alkali-metal-doped portion of the article does not vary by more than 15% from a peak concentration.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of making an alkali metal silicate glass comprising:
preparing an alkali metal feedstock having a first desired level of alkali metal, the alkali metal feedstock being essentially free of a transition metal selected from the group consisting of Co, Cr, Cu, Fe, Mn, Ni, Ti, and V;
combining and mixing the alkali metal feedstock with at least one silicate feedstock to form a precursor material having a second desired level of alkali metal; and
melting the precursor material to form molten glass.

2. (canceled)

3. (canceled)

4. The method of claim 1, further comprising forming the molten glass into a glass article.

5. The method of claim 4, wherein the glass article is a rod-shaped optical fiber precursor.

6. The method of claim 4, wherein forming the molten glass includes casting.

7. The method of claim 4, wherein melting the precursor material into molten glass and forming the molten glass into a glass article occur in a single process.

8. The method of claim 7, wherein the single process comprises piling the precursor material onto a platform positioned in a furnace while translating the platform along the furnace from a first zone wherein the precursor material melts into glass to a second zone wherein the glass rapidly quenches into a solid body.

9. The method of claim 1, wherein melting occurs in a gaseous environment that is substantially free of hydrogen.

10. The method of claim 1, wherein melting occurs in an inert or oxidizing environment.

11. The method of claim 1, wherein the alkali metal feedstock is substantially uniformly distributed throughout the silicate feedstock.

12. The method of claim 1, wherein the second desired level of alkali metal is in a range from approximately 0.035 to 6 mol %.

13. The method of claim 1, wherein the second desired level of alkali metal is in a range from approximately 0.1 to 3 mol %.

14. The method of claim 1, wherein the first desired level of alkali metal is at least 10 mol %.

15. The method of claim 1, wherein the precursor material comprises at least 80 mol % silica.

16. The method of claim 1, wherein the feedstock comprises less than 100 ppb OH.

17. The method of claim 1, wherein preparing the alkali metal feedstock comprises obtaining sand from a substantially high purity silica source.

18. The method of claim 17, wherein preparing the alkali metal feedstock further comprises a step of purifying the sand to reduce a transition metal in the sand to a level below 20 ppm, wherein the transition metal is selected from the group consisting of Co, Cr, Cu, Fe, Mn, Ni, Ti, and V.

19. The method of claim 18, wherein purifying the sand comprises a step of acid leaching the sand.

20. The method of claim 18, further comprising a step of devitrifying the sand into cristobalite.

21. The method of claim 18, wherein preparing the alkali metal feedstock further comprises forming particulate solid from a quantity of the sand and a quantity of a high purity alkali metal source.

22. The method of claim 21, further comprising purifying the particulate solid to reduce the transition metal below detectible limit.

23. The method of claim 22, wherein purifying the particulate solid comprises acid leaching the particulate solid.

24. The method of claim 1, wherein the alkali metal is selected from the group consisting of K, Na, Li, Cs, and Rb, and combinations thereof.

25. A precursor, comprising:
a mixture of an alkali metal feedstock and a silicate feedstock, the mixture comprising 0.035 to 6 mol % of an alkali metal and at least 80 mol % of silica;
wherein the alkali metal feedstock is essentially free of a transition metal selected from the group consisting of Co, Cr, Cu, Fe, Mn, Ni, Ti, and V, and the alkali metal feedstock is substantially uniformly distributed within the precursor.

26. A glass article comprising:
an alkali metal in an amount of 0.035 to 6 mol % and silica in an amount of at least 80 mol %, wherein the glass article is essentially free of a transition metal selected from the group consisting of Co, Cr, Cu, Fe, Mn, Ni, Ti, and V, and the alkali metal is substantially radially uniformly distributed within the glass article.
